(19) United States
(12) Patent Application Publication
(10) Pub. No.: US 2002/0129328 A1
(43) Pub. Date: Sep. 12, 2002

(54) Method for designing optical system, optical system and projection exposure apparatus

(75) Inventor: Hideki Komatsuda, Ageo-shi (JP)

Correspondence Address: Finnegan, Henderson, Farabow,, Garrett & Dunner, L.L.P., 1300 I Street, N.W., Washington, DC, 20005-3315, US

(73) Assignee: NIKON CORPORATION

(21) Appl. No.: 09/991,915

(22) Filed: Nov. 26, 2001

(30) Foreign Application Priority Data
Nov. 27, 2000 (JP) JP2000-358659

(51) Int. Cl. G06F 17/50

(52) U.S. Cl. 716/21

(57) ABSTRACT

When designing an optical system having a surface with a film formed thereupon, the optical system is first designed in conformance to predetermined specifications without taking into consideration the presence of the film and its optical wavefront is calculated (S10). Next, the film to be formed is set, the optical system including the film is designed and its optical wavefront is calculated (S20). The results of the calculation performed in step S10 are compared with the results of the calculation performed in step S20 (S30). If the wavefront aberration calculated in S20 is less significant than the wavefront aberration calculated in S10, the results of the calculation performed in S20 are approved as the design solution, and the next stage of design study begins. If, on the other hand, the wavefront aberration calculated in S20 is more significant than the wavefront aberration calculated in S10 (S40), the operation returns to S20 to redesign the optical system including the film. By adopting the method described above, it becomes possible to assure the required optical performance level by taking into consideration the presence of the film in the optical system having a surface with a film formed thereupon.

### BACKGROUND OF THE INVENTION

1. Field of the Invention

The present invention relates to a projection exposure apparatus employed in a lithography process implemented to manufacture micro devices (semiconductor elements, image-capturing elements, liquid crystal display elements, thin film magnetic heads, CCD elements and the like), an optical system ideal in application in the projection exposure apparatus and an ideal optical system designing method for designing the optical system.

2. Description of the Related Art

As increasingly fine patterns have been used in integrated circuits in recent years, the wavelength of the light generated by an exposure light source utilized in a projection exposure apparatus is becoming shorter. For this reason, an exposure method achieved by using EUV (extreme ultraviolet) radiation as the exposure light source is considered a promising next-generation integrated circuit pattern exposure technology. Since a substance achieving a sufficient transmittance that can be used as a refractive material to constitute an optical system within the wavelength range of EUV radiation which is several nm˜50 nm, the optical system will have to be constituted of a reflective surface alone. Examples of image-forming systems designed with a reflecting surface alone include that disclosed in the U.S. Pat. No. 5,815,310.

### SUMMARY OF THE INVENTION

It is necessary to form a special reflective film for EUV at a reflecting surface at which EUV radiation is to be reflected, since a glossy surface of a simple metal or a simple glass normally used as a base material for constituting a reflecting surface hardly reflects EUV.

A reflective film for EUV, which is formed by laminating a great number of thin films unlike a film used at a dichroic mirror for visible light, is bound to become very thick under normal circumstances. Typical examples of reflective films for EUV include a reflective film formed by alternately laminating molybdenum (Mo) and silicon (Si). If a reflectance of approximately 70% is to be achieved in conjunction with light having a 13 nm wavelength with this film, 40˜50 pairs each constituted of an Mo layer and an Si layer must be laminated. As the thickness of a single pair amounts to approximately 7 nm, the thickness of the entire reflective film is as much as 300˜350 nm.

Since the reflective film has a large film thickness which is more than 20 times the wavelength, there is normally a great difference between the effective reflecting surface at this reflective film and the substrate surface. In addition, the position of the effective reflecting surface changes depending upon the angle of incidence of the light beam entering the reflective film.

However, in designing methods adopted in the related art, the effect of the presence of such a thick film is invariably disregarded and it is assumed that the light beam is reflected at the substrate surface. The design solutions proposed in the related art for EUV projection optical system design, too, have been obtained based upon such design methods, as the change occurring in the optical path length caused by the film, which in fact affects the extent of aberration, has not been taken into consideration in the related art.

Accordingly, an object of the present invention is to assure a required optical performance in an optical system having a surface with a film formed thereupon with the presence of the film taken into consideration.

In order to achieve the object described above, in a first aspect of the present invention, a method for designing an optical system having a surface having a film formed thereupon, comprising a first step in which data on the film are prepared, a second step in which data on the optical system are prepared and a third step in which an optical wavefront of the optical system is calculated by taking into consideration the film based upon the data prepared in the first step and the second step, is provided.

While the design solution of an optical system having a surface with a film formed thereupon is determined without taking into consideration the presence of the film in the related art, the optical wavefront is calculated by incorporating the film according to the present invention to set design conditions very close to the conditions of the actual optical system so that the required optical performance is assured.

It is desirable that the optical system designing method further comprise a fourth step in which at least either the data on the film or the data on the optical system are optimized based upon the results of the calculation of the optical wavefront performed in the third step.

In another aspect of the present invention, an optical system designed through the designing method described above is provided. In yet another aspect of the present invention, a recording medium having recorded therein an optical system designing program, with the designing program having the designing method described above incorporated therein, is provided. In yet another aspect of the present invention, computer receivable carrier wave carrying a signal that contains an optical system designing program, with the signal containing a designing program having the designing method described above incorporated therein, is provided.

In a second aspect of the present invention, an optical system designing method which is a method for designing an image-forming optical system having a surface with a film formed thereupon, comprising a first step in which an optical wavefront of the image-forming optical system is calculated without taking into consideration the presence of the film, a second step in which an optical wavefront of the image-forming optical system is calculated by including the film, a third step in which the results of the calculation performed in the first step are compared with the results of the calculation performed in the second step and a fourth step in which the image-forming optical system is designed so that a wavefront aberration calculated through the second step is less significant compared to a wavefront aberration calculated through the first step, is provided.

This method may be effectively adopted when designing an optical system whose performance is significantly affected by the film thickness and the film characteristics. The method is particularly ideal when designing an optical system that uses EUV radiation or the like with a very short wavelength as a light source and normally includes a film with a thickness which is as large as a multiple of the wavelength. In addition, rough design work including ascertaining the characteristics of the optical system, assuring roughly satisfactory performance and the like can be implemented by performing the first step. Thus, the final design work can be performed by entering detailed film data in the second step and subsequent steps, to achieve efficiency in the design work.

In a third aspect of the present invention, an optical system having a surface with a film formed thereupon which is designed to manifest a less significant wavefront aberration of the optical system calculated by including the film than a wavefront aberration of the optical system calculated without incorporating the presence of the film, is provided.

The optical system adopting the structure described above achieves a high level of performance through optimization implemented by taking the film into consideration. This optical system may be an image-forming optical system. Or it may be another type of optical system such as an afocal system or a condenser optical system. In addition, the surface at which the film is formed may constitute a reflecting surface, and in such a case, the presence of a reflective film is taken into consideration. The optical system may be utilized under EUV radiation, and the present invention may be adopted in an ideal manner in conjunction with such an optical system which normally includes a film with a thickness as large as a multiple of the wavelength and whose performance is affected by the film thickness and the film characteristics to an extent that cannot be disregarded. Furthermore, the present invention may be effectively adopted in an optical system that uses light with a short wavelength such as EUV radiation in which the extent of aberration that is tolerated is small and a high degree of optimal performance must be achieved.

In the optical system, the wavefront aberration of the optical system calculated without taking into consideration the presence of the film may be larger than the wavefront aberration of the optical system calculated by including the film by λ/14 or more in the RMS value with λ representing the design wavelength. When calculating the wavefront aberrations in the optical system, the average of the P-polarized light and the S-polarized light may be used in the calculation.

In a fourth aspect of the present invention, a projection exposure apparatus that projects and exposes a reduced image of a pattern provided at a projection original onto a workpiece, comprising an illuminating optical system that illuminates the projection original and the optical system described above, is provided. In the projection exposure apparatus, the projection original can be placed on an object surface of the optical system and the workpiece can be placed on an image surface of the optical system.

Since an image of the pattern is projected and exposed onto the workpiece by utilizing the optical system achieving high-performance which has been optimized by taking into consideration the presence of the film in the projection exposure apparatus structured as described above, it becomes possible to form a minute circuit pattern with a high resolution.

In a fifth aspect of the present invention, a projection exposure method for projecting and exposing a reduced image of a pattern provided at a projection original onto a workpiece comprising a first step the optical system is prepared, a second step in which the projection original is prepared on an object surface of the optical system, a third step in which the projection original is illuminated, a fourth step in which the workpiece is prepared on an image surface of the optical system and a fifth step in which the reduced image of the pattern is formed onto the workpiece through the optical system, is provided.

In a sixth object of the present invention, a recording medium having recorded therein a designing program for designing an image-forming optical system having a surface with a film formed thereupon, with the designing program comprising a first step in which an optical wavefront of the image-forming optical system is calculated without taking into consideration the presence of the film, a second step in which an optical wavefront of the image-forming optical system is calculated by including the film, a third step in which the results of the calculation performed in the first step are compared with the results of the calculation performed in the second step and a fourth step in which the image-forming optical system is designed so that a wavefront aberration calculated through the second step is less significant compared to a wavefront aberration calculated through the first step, is provided.

In a seventh aspect of the present invention, a computer receivable carrier wave carrying a signal that contains a designing program for designing an image-forming optical system having a surface with a film formed thereupon, with the designing program comprising a first step in which an optical wavefront of the image-forming optical system is calculated without taking into consideration the presence of the film, a second step in which an optical wavefront of the image-forming optical system is calculated by including the film, a third step in which the results of the calculation performed in the first step are compared with the results of the calculation performed in the second step and a fourth step in which the image-forming optical system is designed so that a wavefront aberration calculated through the second step is less significant compared to a wavefront aberration calculated through the first step, is provided.

### BRIEF DESCRIPTION OF THE DRAWINGS

The above and other features of the invention and the concomitant advantages will be better understood and appreciated by persons skilled in the field to which the invention pertains in view of the following description given in conjunction with the accompanying drawings which illustrate preferred embodiments. In the drawings:

FIG. 1 is a flowchart of the optical designing procedure achieved in an embodiment of the present invention;

FIG. 2 is a diagram of the optical path in the optical system achieved in an embodiment of the present invention;

FIG. 3 provides an actual example of design solution data for the optical system in FIG. 2 presented as numerical values;

FIG. 4 is a continuation of the data presented in FIG. 3;

FIG. 5 provides an actual example of film thickness distribution data with respect to the optical system in FIG. 2 presented as numerical values;

FIG. 6 shows the PSF calculated without taking into consideration the presence of the films in the optical system in FIG. 2, with

FIG. 6(a) showing a contour map of the PSF and

FIG. 6(b) presenting a bird's eye view of the PSF;

FIG. 7 shows the PSF calculated by incorporating the presence of the films in the optical system in FIG. 2, with

FIG. 7(a) showing a contour map of the PSF and

FIG. 7(b) presenting a bird's eye view of the PSF;

FIG. 8 illustrates the structure adopted in the projection exposure apparatus achieved in an embodiment of the present invention;

FIG. 9 is a diagram of the optical path in an optical system designed through a designing method of the related art;

FIG. 10 provides an actual example of design solution data for the optical system in FIG. 9 presented as numerical values;

FIG. 11 is a continuation of the data presented in FIG. 10;

FIG. 12 shows the PSF calculated for the optical system shown in FIG. 9, with

FIG. 12(a) showing a contour map of the PSF and

FIG. 12(b) presenting a bird's eye view of the PSF;

FIG. 13 provides an actual example of film thickness distribution with respect to the optical system in FIG. 9 presented as numerical values;

FIG. 14 shows the PSF calculated by incorporating the presence of the films at the optical system in FIG. 9, with

FIG. 14(a) showing a contour map of the PSF and

FIG. 14(b) presenting a bird's eye view of the PSF; and

FIG. 15 shows the PSF calculated by including the film at the M12 surface alone in the optical system shown in FIG. 9, with

FIG. 15(a) showing a contour map of the PSF and

FIG. 15(b) presenting a bird's eye view of the PSF.

### DETAILED DESCRIPTION OF THE PREFERRED EMBODIMENTS

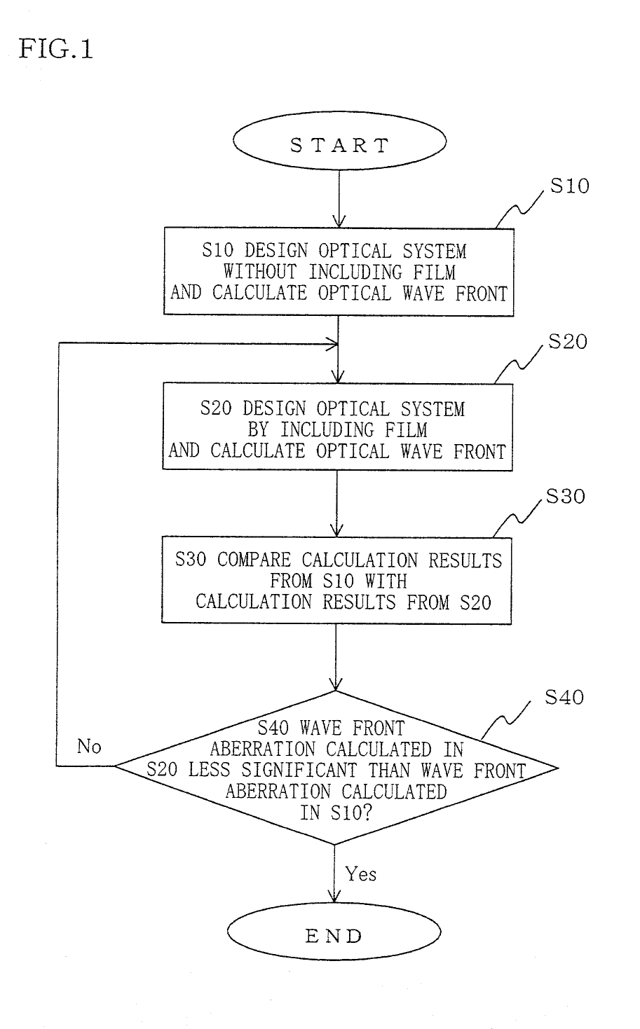

The following is a detailed explanation of the embodiments of the present invention, given in reference to the drawings. FIG. 1 is a flowchart provided to facilitate the explanation of the method for designing an optical system having a surface with a film formed thereupon achieved in an embodiment of the present invention. The procedure that is followed to implement this designing method is now explained in reference to FIG. 1.

First, the optical system is designed in conformance to predetermined specifications without taking into consideration the presence of the film and its optical wavefront aberration is determined through an arithmetic operation by calculating the optical wavefront (S10). Rough design work including reviewing the specific type of optical system being designed, ascertaining the characteristics of the specific type of optical system and roughly assuring a specific performance level may be implemented during this step. Next, a film to be formed is selected, the optical system is designed by taking the film into consideration, and the wavefront aberration of the optical system is determined through an arithmetic operation by calculating the optical wavefront (S20). The film may be designed during this step. Then, the results of the calculation performed in step S 10 are compared with the results of the calculation performed in step S20 (S30).

It is to be noted that the design work performed in steps S10 and S20 includes the optimization of various parameters (data) of the optical system and/or the film.

If the wavefront aberration determined through the arithmetic operation in step S20 is less significant than the wavefront aberration calculated in step S10, the design work is regarded to have yielded an acceptable design solution, and the next stage of design study starts. If, on the other hand, the wavefront aberration calculated in step S20 is more significant than the wavefront aberration calculated in step S10, the operation returns to step S20 (S40) and the optical system including the film is redesigned. When comparing the extents of the wavefront aberrations during this process, a decision may be made as to whether or not the difference between the wavefront aberration calculated in step S10 and the wavefront aberration calculated in step S20 is larger than a given reference value instead of making a simple comparison of their values. The reference value used for this purpose may be an RMS value λ/14.

Under normal circumstances, an aberration free optical system refers to an optical system in which light beams originating from one point on an object along various directions converge onto one point of an image. This means that the lengths of the optical paths of a plurality of light beams connecting two conjugate points are equal to one another. It is not possible to achieve an optical system that does not manifest any aberration at all within a specific field in reality and thus, a certain degree of difference in the optical path length is tolerated. While the degree to which the optical paths are allowed to manifest a difference varies depending upon the purposes of use of the optical system, an RMS (root mean square) which is approximately 1/14 of the wavelength λ is considered to be practically aberration free by taking into consideration the inconsistency manifesting in the optical path length difference which is normally referred to as a wavefront aberration.

It is even more desirable to use an RMS value of λ/20 as the reference value.

The issue of the P-polarized light and the S-polarized light must be addressed when calculating the optical wavefronts in steps S10 and S20. When light enters a reflecting surface obliquely, the effective reflecting surfaces at which the P-polarized light and the S-polarized light are reflected differ slightly, and it is not possible to reduce the phase difference between the P-polarized light and the S-polarized light through optical design. As one solution, an optical wavefront may be calculated by using the average of the P-polarized light and the S-polarized light.

It is to be noted that while the operation returns to step 20 if the wavefront aberration calculated in step S20 is more significant than the wavefront aberration calculated in step S10 in the embodiment, the redesign work may be implemented by returning to step S10 under certain circumstances. In addition, while the wavefront aberrations represent the physical quantities compared with each other in step S40, other physical quantities such as MTFs (modulation transfer functions) may be used alone or in combination with the wavefront aberrations. Furthermore, depending upon the type of optical system, the design work may be implemented by skipping step S10. The designing method described above may be adopted when designing various types of optical systems including afocal systems and condenser optical systems as well as image-forming systems.

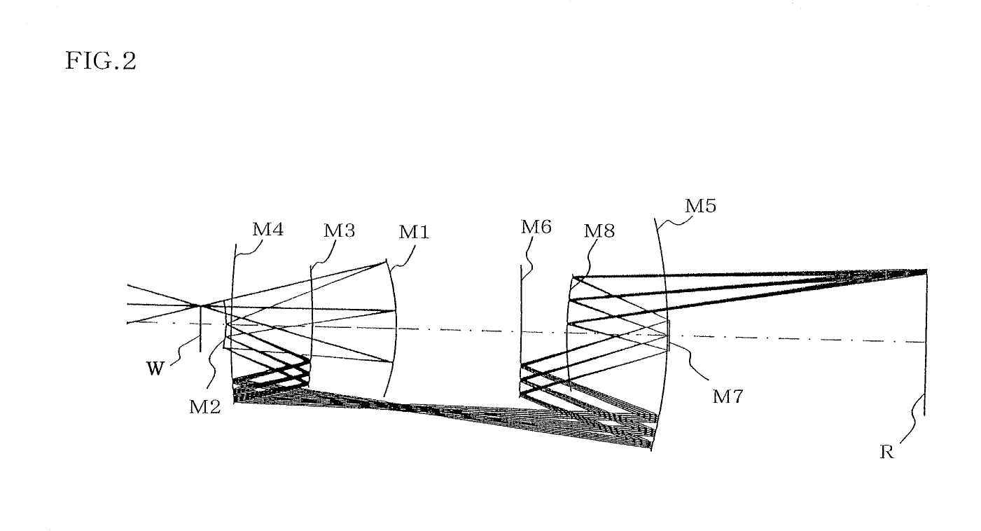

FIG. 2 is a diagram of the optical paths in an image-forming optical system designed through the method described above. This optical system is an image-forming optical system having eight aspherical light-reflecting surfaces and forms an image of an object placed on a first surface R onto a second surface W via these reflecting surfaces. It uses EUV radiation and a reflective film for EUV radiation is formed at each of the reflecting surfaces. The individual reflecting surfaces are assigned with reference codes M1, M2, M3, M4, M5, M6, M7 and M8 starting from the W side toward the R side along the optical path.

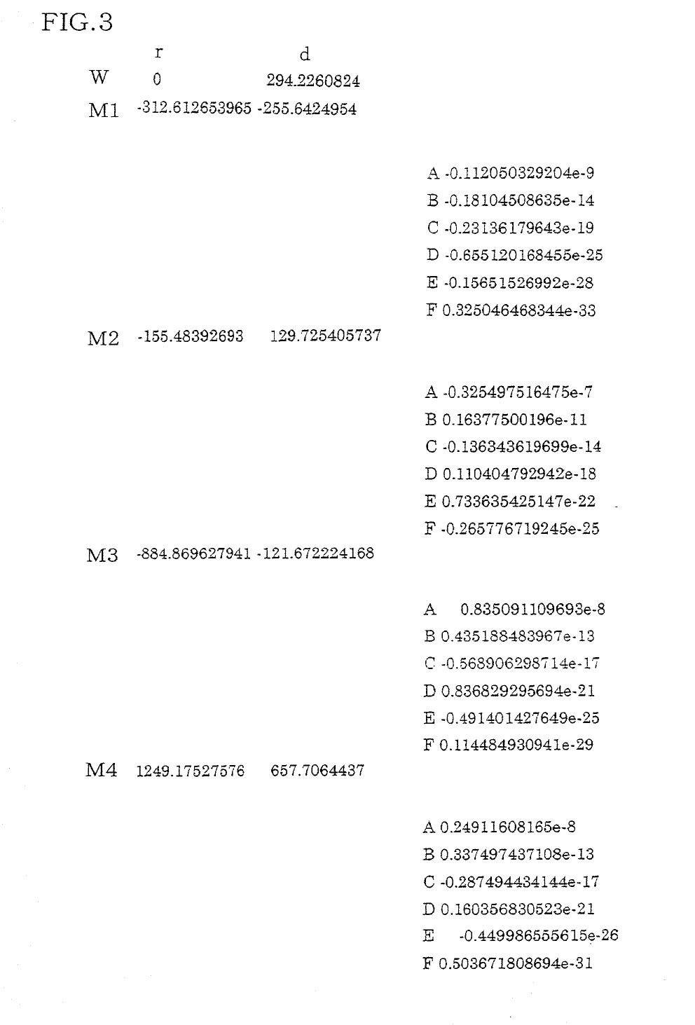

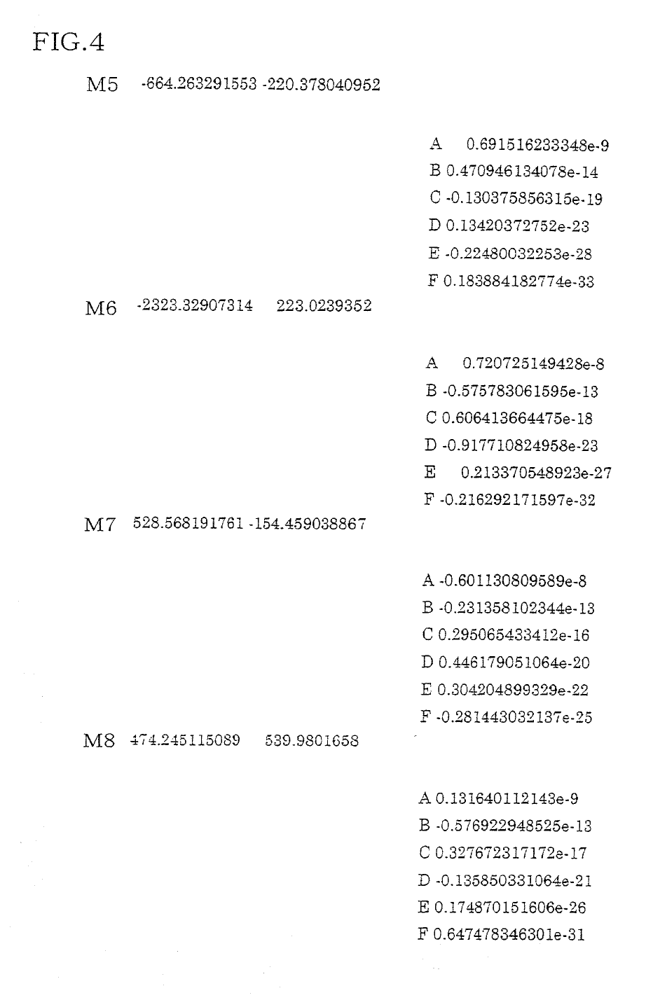

FIGS. 3 and 4 present the design solution data obtained for this optical system. In the data, r represents the radius of the curvature, d represents the distance to the next surface and A, B, C, D, E and F represent aspherical coefficients defined as follows.

$$Z = \frac{{h}^{2}}{r \{ 1 + \sqrt{( 1 - \frac{{h}^{2}}{{r}^{2}} )} \}} + A {h}^{4} + B {h}^{6} + C {h}^{8} + D {h}^{10} + E {h}^{12} + F {h}^{14}$$

with Z: the extent of sag amount relative to a flat surface

h: height measured from the optical axis

In this optical system, the W-side numerical aperture (NA) is 0.25, the field at the W surface constitutes an annular area with a 25˜27 mm radius, the clear aperture of the M7 also represents the aperture stop and telecentricity is achieved on the W side.

An EUV reflective film requires rigorous control to achieve the desired angular characteristics, which means that if the angle of incidence of a light beam is different from an estimated angle, a predetermined reflectance cannot be achieved. For this reason, it is necessary to achieve a specific film thickness distribution for the EUV reflective film in order to assure the required performance level in the optical system. The film thickness is normally set to achieve a rotationally symmetrical distribution so as to facilitate the production control.

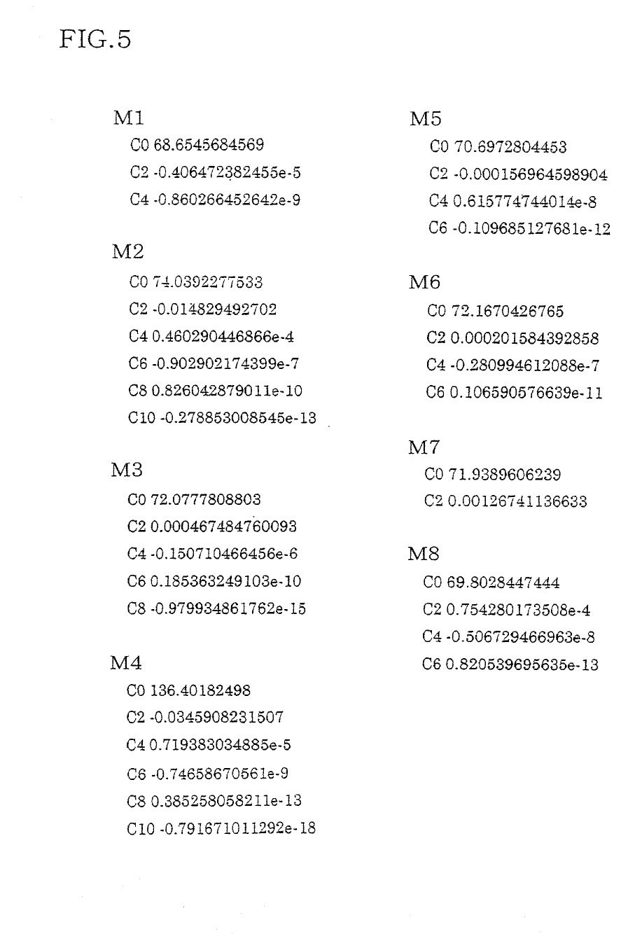

In this embodiment, the basic makeup of an EUV reflective film is constituted of films with each pair comprising a film formed by laminating 50 pairs of an Mo layer with a 0.033 nm thickness and an Si layer with a 0.067 nm thickness so as to allow the Mo layers and the Si layers to be stacked alternately and the actual film thickness is obtained by multiplying a C0+C2h²+C4h⁴+C6h⁶+C8h⁸+C10h¹⁰. With h representing the height measured from the optical axis and C0˜C10 representing coefficients that vary among the individual surfaces. FIG. 5 presents the values of the coefficients set for the individual surfaces.

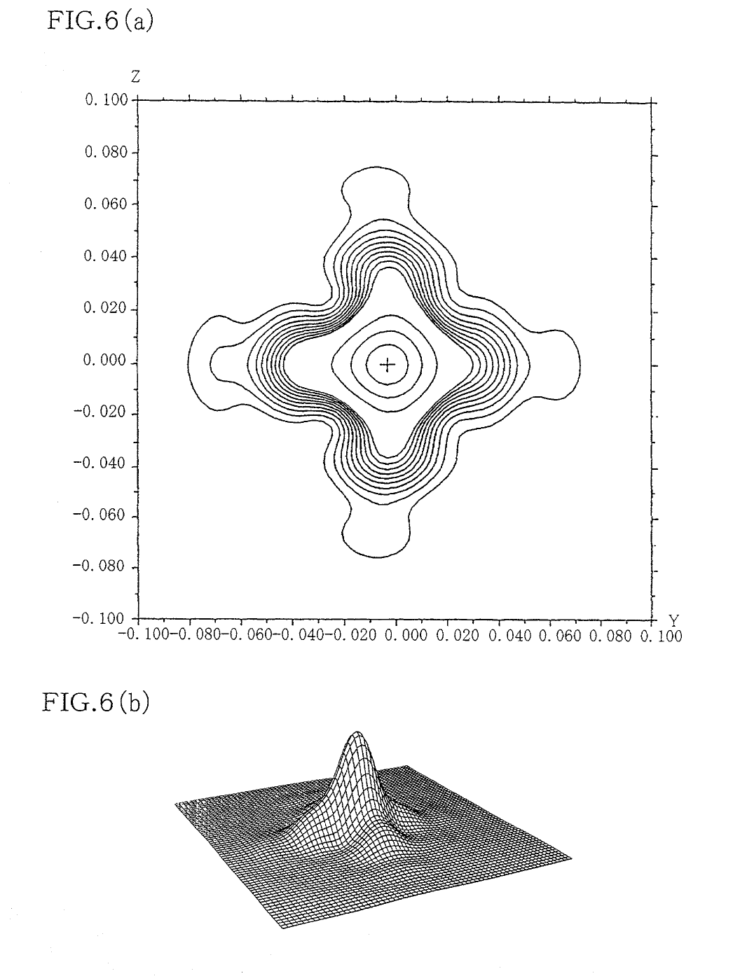

FIG. 6 shows the PSF (point spread function) of the optical system calculated at a 26 mm height on the W surface in conjunction with a 13.4 nm wavelength without taking into consideration the presence of these reflective films, i.e., by assuming that the substrate surfaces constitute reflecting surfaces. FIG. 6(a) is a PSF contour map and FIG. 6(b ) is a bird's eye view of the PSF. The PSF manifests a peak value of 0.4766. When this peak value is converted to a wavefront aberration, its RMS value is 0.123 λ, which will not be considered as an acceptable level for a design solution by the existing standard.

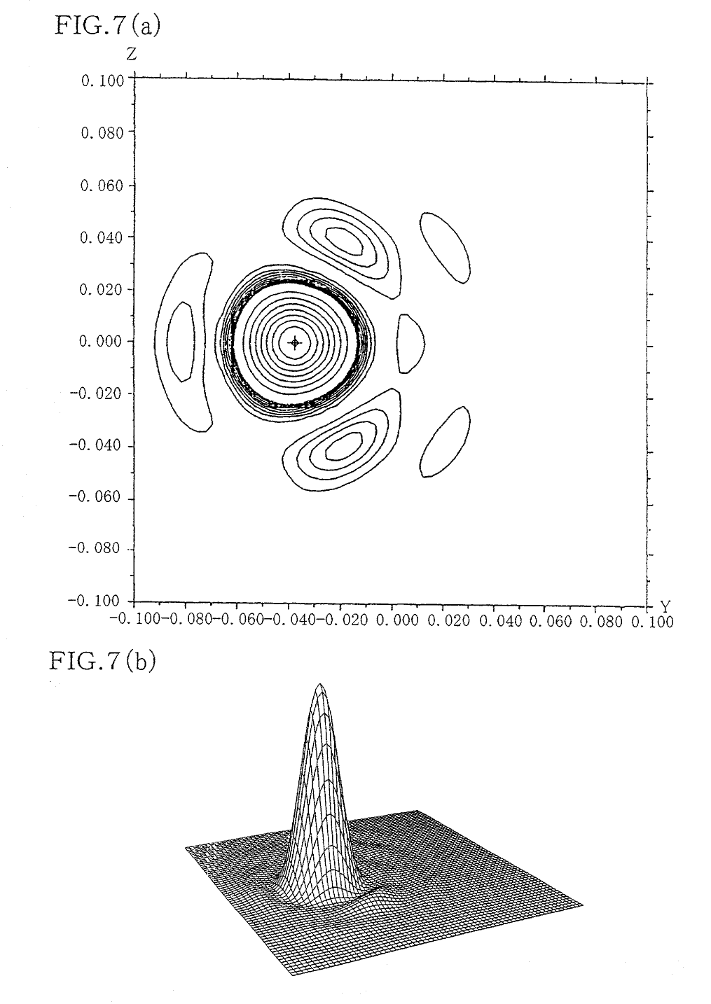

FIG. 7 shows the PSF of the optical system calculated under the same conditions as those under which the PSF in FIG. 6 is calculated except that the calculation is performed by taking into consideration the presence of the reflective films described above. FIG. 7(a) shows the PSF contour map and FIG. 7(b ) shows a bird's eye view of the PSF. The PSF manifests a peak value of 0.9162 which is converted to an RMS value of 0.046 λ representing the wavefront aberration. The value indicates that the optical system can be used in a semiconductor integrated circuit exposure apparatus without problems.

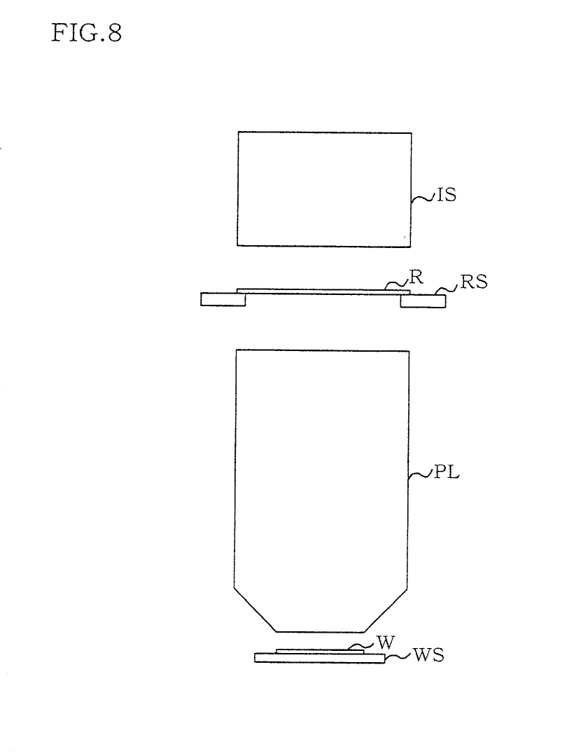

FIG. 8 shows the structure assumed in a projection exposure apparatus which employs the image-forming optical system shown in FIG. 2 as a projection optical system PL. In the figure, the first surface R in FIG. 2 is shown as an object surface and the second surface W in FIG. 2 is shown as an image surface. It is to be noted that since the object surface and the image surface have a conjugate relationship to each other, the image-forming relationship is retained even when the two surfaces are switched.

On the object surface of a projection optical system PL, a reticle R, which constitutes the projection original having a specific circuit pattern formed therein, is placed and on the image surface of the projection optical system PL, a wafer W having a photoresist applied thereupon which constitutes a workpiece is placed. The reticle R is held on a reticle stage RS, whereas the wafer W is held onto a wafer stage WS. Above the reticle R, an illuminating optical device IS, which includes an EUV radiation source constituting an exposure light source and uniformly illuminates the reticle R is provided.

The exposure light supplied from the illuminating optical device IS illuminates the reticle R. An image of the pattern at the illuminated reticle R is reduced at a specific projection factor via the projection optical system PL and is exposed and transferred onto the wafer W.

Next, an EUV image-forming optical system designed through the designing method in the related art is explained for comparison.

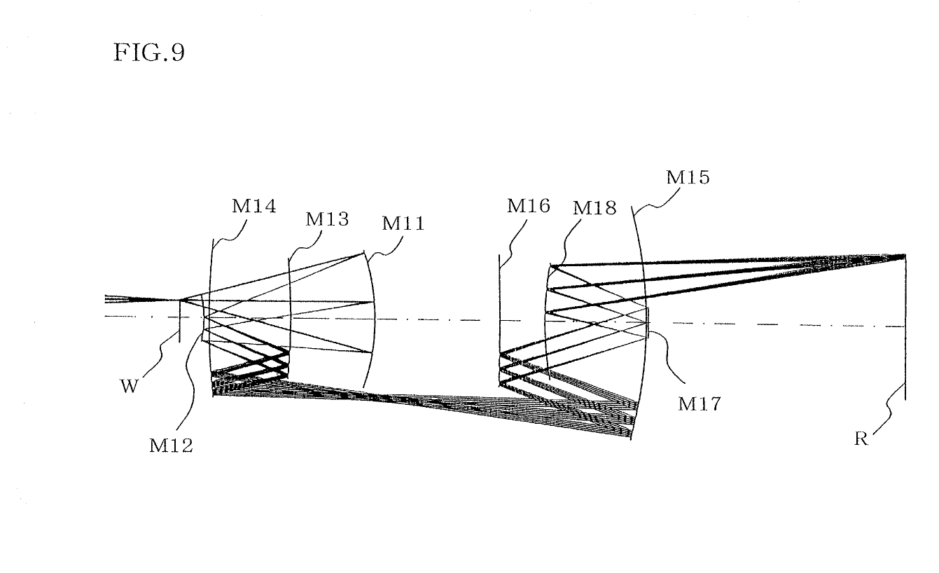

FIG. 9 is a diagram of the optical paths of an EUV image-forming optical system designed through the designing method in the related art. This optical system is an image-forming optical system having eight aspherical radiation-reflecting surfaces and forms an image of an object on a first surface R onto a second surface W via these reflecting surfaces. While a film is formed at each reflecting surface in reality, the presence of the film is not taken into consideration at the design stage. The individual reflecting surfaces are assigned with reference codes M11, M12, M13, M14, M15, M16, M17 and M18 starting from the W side toward the R side along the optical path.

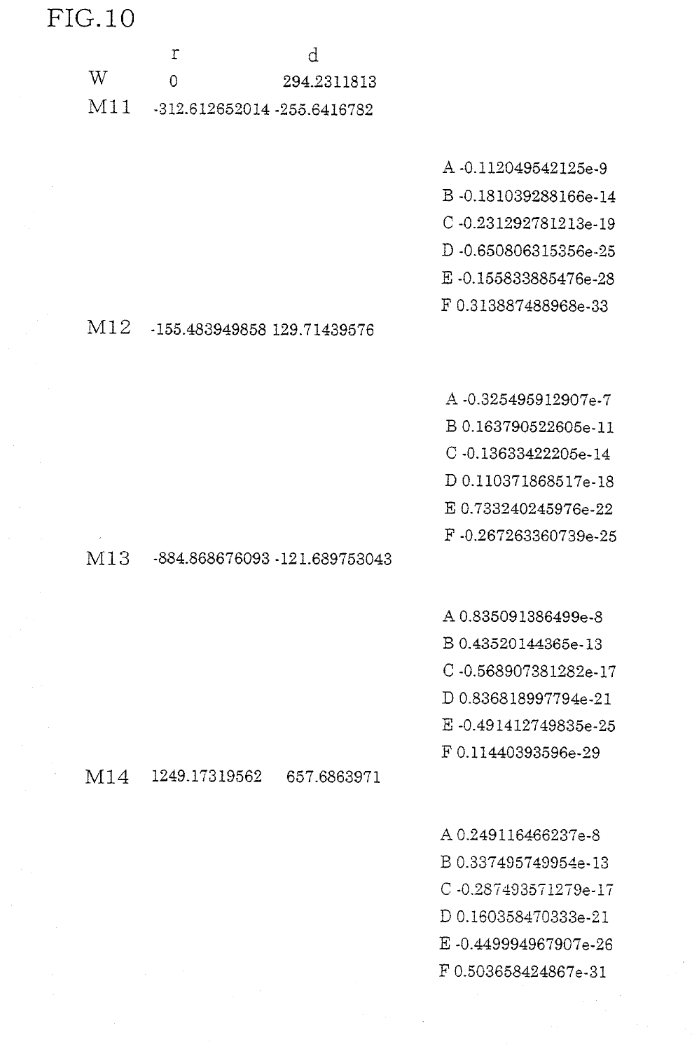

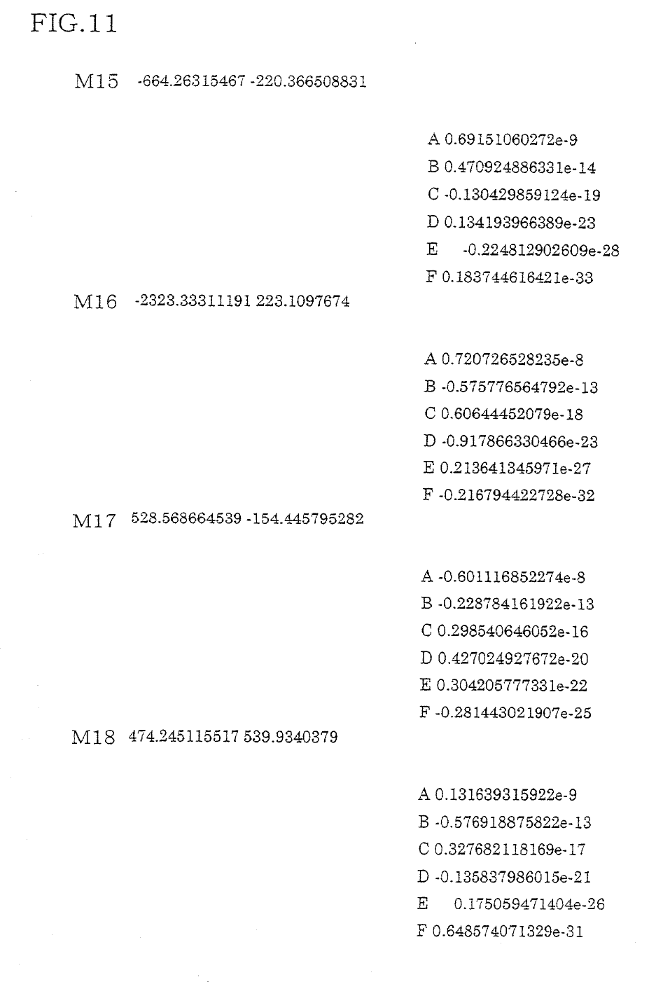

FIGS. 10 and 11 present the design solution data obtained for this optical system. In the data, r represents the radius of the curvature, d represents the distance to the next surface and A, B, C, D, E and F represent aspherical coefficients defined earlier. In this optical system, the W-side numerical aperture (NA) is 0.25, the field at the W surface constitutes an annular area with a 25˜27 mm radius, the clear aperture of the M7 also represents the aperture stop and telecentricity is achieved on the W side.

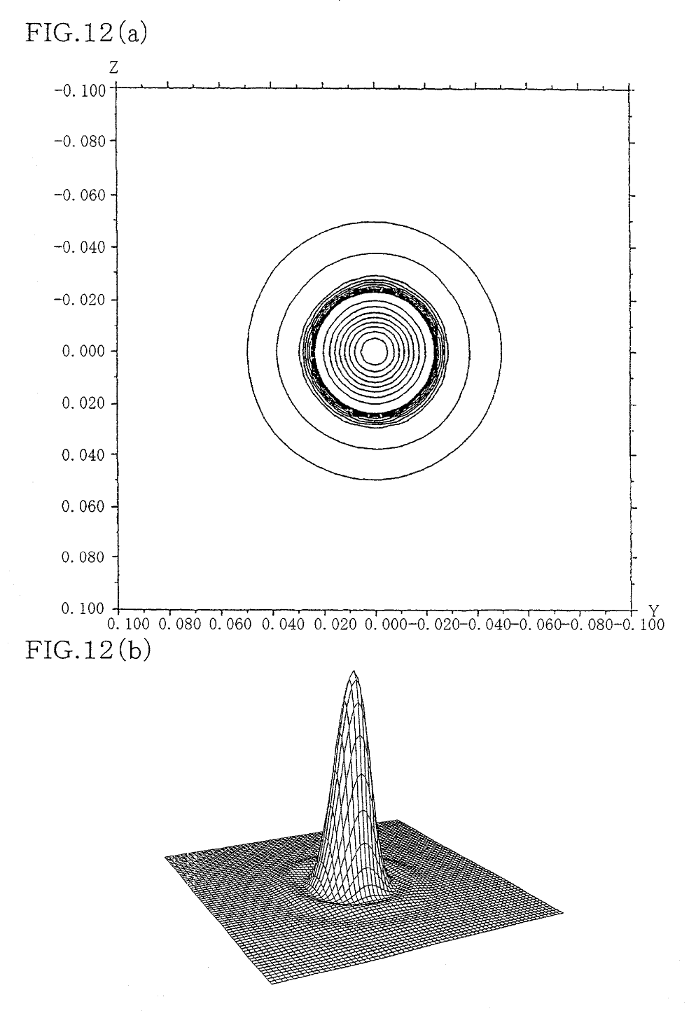

FIG. 12 shows the PSF obtained by calculating the optical wavefront of the optical system at a 26 mm height on the W surface in conjunction with a 13.4 nm wavelength without taking into consideration the presence of the films. FIG. 12(a) is a PSF contour map and FIG. 12(b ) is a bird's eye view of the PSF. The peak value of the PSF is 0.9999, which means that the RMS value representing the wavefront aberration is approximately 0.0016 λ, which, in turn, indicates that the optical system manifests practically no aberration.

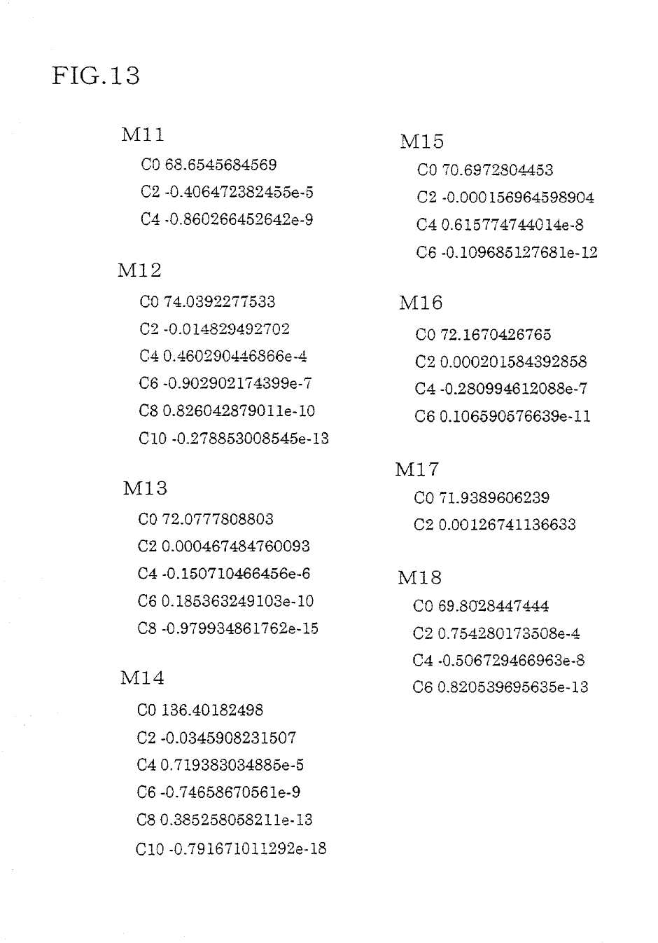

However, the optical system is actually utilized with a reflective film for EUV radiation applied to the reflecting surfaces. The basic makeup of each film is achieved by laminating 50 pairs of films with each pair constituted of an Mo layer with a 0.033 nm thickness and an Si layer with a 0.076 nm thickness so as to allow the Mo layers and the Si layers to be stacked alternately. The actual film thickness is calculated by multiplying the thickness of the basic film by C0+C2h²+C4h⁴+C6h⁶+C8h⁸+C10h¹⁰. With h representing the height measured from the optical axis and C0˜C10 representing coefficients which are varied for the individual surfaces. FIG. 13 shows the values of the coefficients set for the individual surfaces.

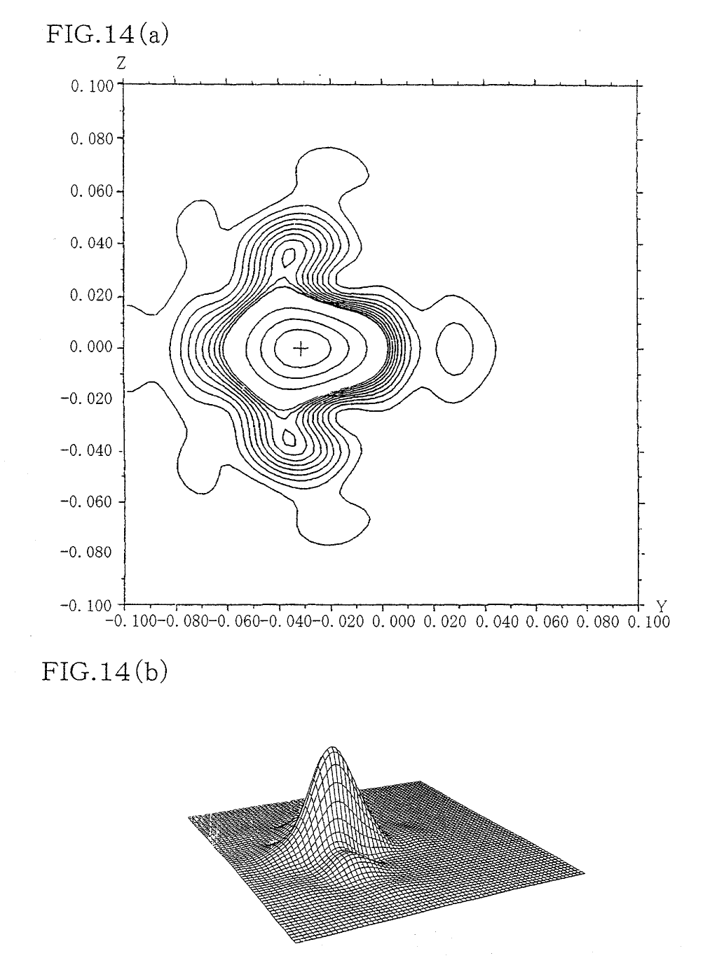

Next, the optical wavefront of the optical system is calculated by taking into consideration the presence of the EUV reflective films, the film thickness distribution data of which are presented in FIG. 13. FIG. 14 shows the PSF of the optical system calculated under conditions identical to those set when calculating the PSF shown in FIG. 12 except that the calculation is performed by including the films. FIG. 14(a) is a PSF contour map and FIG. 14(b ) presents a bird's eye view of the PSF. While FIG. 14 is drawn at the same scale as FIG. 12, it clearly shows a lower peak with a wider base, compared to FIG. 12. The peak value of the PSF in FIG. 14 is 0.4973, which translates to an RMS value of approximately 0.11 λ to represent the wavefront aberration. This RMS value clearly indicates the performance level of the optical system is not high enough to be utilized in a semiconductor integrated circuit exposure apparatus.

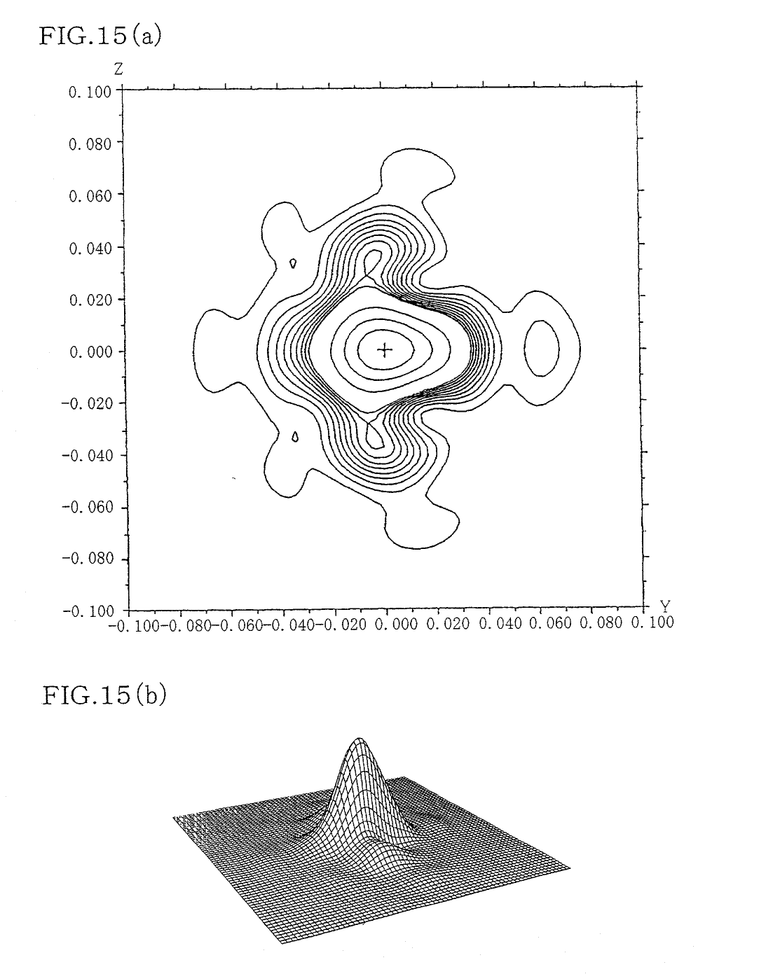

It has been confirmed that the pronounced difference in the performance ascertained by comparing the PSF calculated without including the films and the PSF calculated by taking into consideration the presence of the films occurs at the surface M12. FIG. 15 shows the PSF of the optical system calculated by assuming that a film is formed only at the M12 and EUV radiation is reflected at the substrate surfaces at the remaining surfaces where no film is present with the other conditions set identical to those under which the PSF in FIG. 14 is calculated. FIG. 15(a) shows a PSF contour map and FIG. 15(b ) presents a bird's eye view of the PSF. FIG. 15 is quite similar to FIG. 14, indicating that the performance at the surface M12 greatly affects the overall performance level.

It has also been confirmed that essentially identical design solutions are obtained by different designers for the M11 and M12, as long as the design work is implemented in conformance to similar specifications. This implies that the phenomenon described above is not inherent to this instance alone and that design solutions obtained in conformance to similar specifications lead to roughly similar results.

As described above, the optical system in the example provided for comparison does not achieve a performance level high enough to be utilized in a semiconductor integrated circuit exposure apparatus.

It is to be noted that while it is conceivable to avoid such degradation in the performance level attributable to the presence of the films by modifying the design of the films to eliminate any significant difference between the results of evaluations conducted without taking into consideration the presence of the films and conducted by incorporating the presence of the films, an EUV reflective film must have a large thickness which is as much as a multiple of the wavelength to assure the desired performance level as explained earlier. Thus, it is extremely difficult to design an optical system for EUV radiation in which no significant difference manifests between the evaluation conducted without taking into consideration the presence of the films and the evaluation conducted by including the films.

As explained in detail above, while the design solution in an optical system having surfaces with a film formed thereupon is obtained without taking into consideration the presence of the films in the related art, the design solution is obtained by including the films in the calculation of the optical wavefront in the embodiments to set the design conditions very close to the conditions of the actual optical system and ultimately to assure the required optical performance level. In particular, the present embodiment is effective when adopted in an optical system employing a light source which emits light with a short wavelength such as EUV radiation and includes a film whose thickness is as much as a multiple of the wavelength. The thickness of a reflective film in such an EUV projection optical system is at least 20 times the wavelength. As described earlier, there is a great difference between the effective reflecting surface at this reflective film and the substrate surface. In addition, the position of the effective reflecting surface may vary within the range matching the thickness of the reflective film, i.e., within the range which is at least as large as 20 times the wavelength. The effectiveness of the embodiments becomes clearer when one bears in mind that the allowable wavefront aberration range over which an optical system may be regarded as an aberration free optical system is λ/14 as described earlier.

In addition, a pattern image can be projected and exposed onto a workpiece by employing a high-performance optical system which has been optimized by taking into consideration the presence of the reflective film, and thus, a projection exposure apparatus capable of forming a minute circuit pattern with high resolution can be provided by adopting the embodiments.

While the invention has been particularly shown and described with respect to preferred embodiments thereof by referring to the attached drawings, the present invention is not limited to these examples and it will be understood by those skilled in the art that various changes in form and detail may be made therein without departing from the spirit, scope and teaching of the invention.

As explained in detail above, while the design solution in an optical system having a surface with a film formed thereupon is obtained without taking into consideration the presence of the film in the related art, the design solution is obtained by including the film in the calculation of the optical wavefront according to the present invention to set the design conditions very close to the conditions of the actual optical system and ultimately to assure the required optical performance level. In particular, the present invention is effective when adopted in an optical system employing a light source which emits light with a short wavelength such as EUV radiation and includes a film whose thickness is as much as a multiple of the wavelength. In addition, in another aspect of the present invention, a pattern image can be projected and exposed onto a workpiece by employing a high-performance optical system which has been optimized by taking into consideration the presence of the film, and thus, a projection exposure apparatus capable of forming a minute circuit pattern with high resolution can be provided.

What is claimed is:

1. A method for designing an optical system having a surface with a film formed thereupon, comprising the steps of:
a first step for preparing a data on the film;
a second step for preparing a data on said optical system; and
a third step for calculating an optical wavefront of said optical system including the film based upon the data prepared in said first step and said second step.

2. A method for designing an optical system according to claim 1, further comprising:
a fourth step for optimizing at least one of said data on the film and said data on the optical system based upon the results of the calculation of the optical wavefront performed in said third step.

3. An optical system designed through a designing method according to claim 1.

4. An optical system designed through a designing method according to claim 2.

5. A recording medium having recorded therein a designing program for designing an optical system, wherein:
a designing program comprises a designing method according to claim 1.

6. A computer receivable carrier wave carrying a signal that contains a designing program for designing an optical system, wherein:
said signal contains a designing program that comprises a designing method according to claim 1.

7. A method for designing an image-forming optical system having a surface with a film formed thereupon, comprising the steps of:
a first step for calculating an optical wavefront of said image-forming optical system without taking into consideration the presence of the film;
a second step for calculating an optical wavefront of said image-forming optical system with taking into consideration the presence of the film;
a third step for comparing the results of the calculation performed in said first step and the results of the calculation performed in said second step; and
a fourth step designating said image-forming optical system so that a wavefront aberration calculated through said second step is less significant compared to a wavefront aberration calculated through said first step.

8. An optical system having a surface with a film formed thereupon designed to manifest a less significant wavefront aberration of said optical system calculated by including the film than a wavefront aberration of said optical system calculated without taking the film into consideration.

9. An optical system according to claim 8, wherein:
said optical system is an image-forming optical system.

10. An optical system according to claim 9, wherein:
said surface with the film formed thereupon is a reflecting surface.

11. An optical system according to claim 10, wherein:
said optical system is utilized under EUV radiation.

12. An optical system according to claim 8, wherein:
said surface with the film formed thereupon is a reflecting surface.

13. An optical system according to claim 12, wherein:
said optical system is utilized under EUV radiation.

14. An optical system according to claim 8, wherein:
the wavefront aberration said optical system calculated without taking into consideration the presence of the film is larger than the wavefront aberration of said optical system calculated by including the film by λ/14 or more in RMS with λ representing the design wavelength.

15. An optical system according to claim 9, wherein:
the wavefront aberration of said optical system calculated without taking into consideration the presence of the film is larger than the wavefront aberration of said optical system calculated by including the film by λ/14 or more in RMS with λ representing the design wavelength.

16. An optical system according to claim 10, wherein:
the wavefront aberration of said optical system calculated without taking into consideration the presence of the film is larger than the wavefront aberration of said optical system calculated by including the film by λ/14 or more in RMS with λ representing the design wavelength.

17. An optical system according to claim 16, wherein:
said optical system is utilized under EUV radiation.

18. An optical system according to claim 8, wherein:
the average of a P-polarized light and an S-polarized light is used when calculating the wavefront aberrations.

19. A projection exposure apparatus that projects and exposes a reduced image of a pattern provided at a projection original onto a workpiece, comprising:
an illuminating optical system that illuminates the projection original; and
an optical system according to claim 9, wherein;
the projection original can be placed on an object surface of said optical system and the workpiece can be placed on an image surface of said optical system.

20. A projection exposure method for projecting and exposing a reduced image of a pattern provided at a projection original onto a workpiece, comprising the steps of:
a first step for preparing an optical system according to claim 9;
a second step for preparing the projection original on an object surface of said optical system;
a third step for illuminating the projection original;
a fourth step for preparing the workpiece on an image surface of said optical system; and
a fifth step for forming the reduced image of the pattern on the workpiece through said optical system.

21. A recording medium having recorded therein a designing program for designing an image-forming optical system having a surface with a film formed thereupon,
wherein said a designing program comprising;
a first step for calculating an optical wavefront of said image-forming optical system without taking into consideration the presence of the film;
a second step for calculating an optical wavefront of said image-forming optical system with taking into consideration the presence of the film;
a third step for comparing the results of the calculation performed in said first step and the results of the calculation performed in said second step; and
a fourth step for designing said image-forming optical system so that a wavefront aberration calculated through said second step is less significant compared to a wavefront aberration calculated through said first step.

22. A computer receivable carrier wave carrying a signal that contains a designing program for designing an image-forming optical system having a surface with a film formed thereupon,
wherein said designing program comprising:
a first step for calculating an optical wavefront of said image-forming optical system without taking into consideration the presence of the film;
a second step for calculating an optical wavefront of said image-forming optical system with taking into consideration the presence of the film;
a third step comparing the results of the calculation performed in said first step and the results of the calculation performed in said second step; and
a fourth step for designing said image-forming optical system so that a wavefront aberration calculated through said second step is less significant compared to a wavefront aberration calculated through said first step.
